(19) United States
(12) Patent Application Publication
(10) Pub. No.: US 2026/0121407 A1
(43) Pub. Date: Apr. 30, 2026

(54) System And Method For Enhanced Droop Control

(71) Applicant: BLOOM ENERGY CORPORATION, San Jose, CA (US)

(72) Inventors: Chaitanya Mandela, Bangalore (IN); Ranganathan Gurunathan, Bangalore (IN); Ayyappa Rudrasimha Yedida, Bangalore (IN); Saravanakumar Narayanasamy, Bangalore (IN); Vishal Anand Aisur Gopalakrishnan, Bangalore (IN); Badrinarayanan Thiruvengadaswamy, Bangalore (IN); Beau E. Baker, San Jose, CA (US); Vignan Reddy Bommireddy, San Jose, CA (US); Mehdi Ebad, San Jose, CA (US)

(21) Appl. No.: 19/372,711

(22) Filed: Oct. 29, 2025

Related U.S. Application Data
(60) Provisional application No. 63/713,335, filed on Oct. 29, 2024.

(51) Int. Cl. H02J 3/24; H02J 3/12; H02J 3/46

(52) U.S. Cl. CPC H02J 3/00142; H02J 3/12; H02J 3/472; H02J 2103/35

(57) ABSTRACT

A method includes controlling an inverter to operate at an initial frequency, where the inverter is coupled to a load and a source. The method also includes sensing a load power, generating a droop set point frequency in response to a change in the load power, applying a first proportional gain constant (Kₚ₁) and a first integral gain constant (Kᵢ₁) to a rate of change of the droop set point frequency to generate an adaptive ramp rate, and controlling a frequency of the inverter based on the initial frequency and the adaptive ramp rate.

### CROSS-REFERENCE TO RELATED APPLICATIONS

This application claims the priority to and benefits of U.S. Provisional Patent Application No. 63/713,335 filed on Oct. 29, 2024, which is incorporated herein by reference in its entirety.

### TECHNICAL FIELD

The present disclosure relates to control systems and methods for a grid-forming inverter.

### BACKGROUND

Electrical power systems can be used to provide electrical power to one more loads such as buildings, appliances, lights, tools, air conditioners, heating units, factory equipment and machinery, power storage units, computers, data centers, security systems, and the like. The electricity used to power loads is often received from an electrical grid.

Microgrids include multiple, paralleled energy sources to provide power to a load. The energy sources may include synchronous machines, direct current (DC) energy sources (e.g., solar cells), or a combination thereof. In alternating current (AC) microgrids, inverters may be coupled to the DC energy source(s) to perform DC-to-AC conversion to provide AC power to the load.

A microgrid can also be integrated into the electrical grid infrastructure. Thus, the energy sources of the microgrid can be used in conjunction with the electrical grid, and a plurality of energy sources may be combined in a single electrical power system to provide electrical power to one or more loads.

### SUMMARY

In an embodiment of the present disclosure, a method includes controlling an inverter to operate at an initial frequency, where the inverter is coupled to a load and a source. The method also includes sensing a load power, generating a droop set point frequency in response to a change in the load power, applying a first proportional gain constant (Kₚ₁) and a first integral gain constant (Kᵢ₁) to a rate of change of the droop set point frequency to generate an adaptive ramp rate, and controlling a frequency of the inverter based on the initial frequency and the adaptive ramp rate.

In another embodiment of the present disclosure, a method includes sensing an output power of an inverter, where the inverter is coupled to a load and a source. The method also includes applying a droop curve (m) to the output power of the inverter to generate a droop set point frequency in response to the output power, and generating a no load frequency by applying a second proportional gain constant (Kₚ₂) and a second integral gain constant (Kᵢ₂) to a difference between the output power of the inverter and a reference power (P_{ref}). In this method, Kᵢ₂=m*Kₚ₂*P₀, P₀ is a system power constant, and the output power of the inverter is controlled based on the no load frequency.

In yet another embodiment of the present disclosure, a method includes sensing an output power of an inverter, where the inverter is coupled to a load and a source. The method also includes applying a droop curve (m) to a component of the output power of the inverter to generate a droop set point frequency in response to the output power, deriving a feedback voltage based on the output power of the inverter, and generating a direct current (DC) frequency by applying a third proportional gain constant (Kₚ₃) and a third integral gain constant (Kᵢ₃) to a difference between the feedback voltage and a DC reference voltage. In this method, wherein Kᵢ₃=m*Kₚ₃*P₀, P₀ is a system power constant, and the output power of the inverter is controlled based on the DC frequency.

In still another embodiment of the present disclosure, a microgrid includes a power source, a load, and an inverter electrically coupled to the power source and configured to provide a load power to the load. The inverter comprises a controller configured to control the inverter to operate at an initial frequency, sense the load power, generate a droop set point frequency in response to a change in the load power, apply a first proportional gain constant (Kₚ₁) and a first integral gain constant (Kᵢ₁) to a rate of change of the droop set point frequency to generate an adaptive ramp rate, and control a frequency of the inverter based on the initial frequency and the adaptive ramp rate.

In an embodiment of the present disclosure, a microgrid includes a power source, a load, and an inverter electrically coupled to the power source and configured to provide a load power to the load. The inverter comprises a controller configured to apply a droop curve (m) to an output power of the inverter to generate a droop set point frequency in response to the output power, and generate a no load frequency by applying a second proportional gain constant (Kₚ₂) and a second integral gain constant (Kᵢ₂) to a difference between the output power of the inverter and a reference power (P_{ref}). In this example, Kᵢ₂=m*Kₚ₂*P₀, P₀ is a system power constant, and the output power of the inverter is controlled based on the no load frequency.

In another embodiment of the present disclosure, a microgrid includes a power source, a load, and an inverter electrically coupled to the power source and configured to provide a load power to the load. The inverter comprises a controller configured to apply a droop curve (m) to a component of an output power of the inverter to generate a droop set point frequency in response to the output power, derive a feedback voltage based on the output power of the inverter, and generate a direct current (DC) frequency by applying a third proportional gain constant (Kₚ₃) and a third integral gain constant (Kᵢ₃) to a difference between the feedback voltage and a DC reference voltage. In this example, Kᵢ₃=m*Kₚ₃*P₀, P₀ is a system power constant, and the output power of the inverter is controlled based on the DC frequency.

Further embodiments of the present disclosure may also include a system as substantially described herein, a method as substantially described herein, or a controller for a grid-forming inverter as substantially described herein.

Embodiments described herein include a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the concepts and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic illustration of a circuit model of a grid-forming inverter;

FIG. 2 is a schematic illustration of a droop control implementation for a grid-forming inverter;

FIG. 3 is a schematic illustration of a closed loop model of droop control for a grid-forming inverter;

FIG. 4 is a schematic illustration of a closed loop model of frequency control for a synchronous generator;

FIG. 5 is a schematic illustration of the closed loop model of droop control with a rate limiter for a grid-forming inverter;

FIG. 6 is a schematic illustration of a circuit model for two-source parallel operation in response to a step load condition;

FIG. 7 is a graphical illustration of active power and frequency responses of a synchronous generator and a grid-forming inverter in response to a step load condition;

FIG. 8 is a schematic illustration of a closed loop model of droop control with an adaptive ramp controller for a grid-forming inverter in accordance with an embodiment of the present disclosure;

FIG. 9 is a graphical illustration of active power and frequency responses of a synchronous generator and a grid-forming inverter in response to a step load condition, in which the inverter implements closed loop droop control with an adaptive ramp controller in accordance with an embodiment of the present disclosure;

FIG. 10 is a graphical illustration of active power and frequency responses of two grid-forming inverters in response to a step down load condition, in which one of the inverters implements a closed loop droop control with an adaptive ramp controller in accordance with an embodiment of the present disclosure;

FIG. 11 is a schematic illustration of the closed loop model of droop control that models load disturbances and droop curve offset;

FIG. 12 is a graphical illustration of power control through droop curve offset adjustment;

FIG. 13 is a schematic illustration of a model of a power control loop that employs offset control in accordance with an embodiment of the present disclosure;

FIG. 14 is a schematic illustration of a model of a simplified power control loop in accordance with an embodiment of the present disclosure;

FIG. 15 is a schematic illustration of a model of a maximum power control loop in accordance with an embodiment of the present disclosure;

FIG. 16 is a schematic illustration of a model of a minimum power control loop in accordance with an embodiment of the present disclosure;

FIG. 17 is a schematic illustration of a model of a DC bus control loop in accordance with an embodiment of the present disclosure;

FIG. 18 is a graphical illustration of power and frequency responses of a generator and a grid-forming inverter in response to a step down load condition, which illustrates the effect of the inverter implementing a minimum power control loop in accordance with an embodiment of the present disclosure;

FIG. 19 is a schematic illustration of a DC braking module in accordance with an embodiment of the present disclosure; and

FIG. 20 is a schematic illustration of a DC braking module control loop in accordance with an embodiment of the present disclosure.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct engagement between the two devices, or through an indirect connection that is established via other devices, components, nodes, and connections. As used herein, the terms “approximately,” “about,” “substantially,” and the like mean within 10% (i.e., plus or minus 10%) of the recited value. Thus, for example, a recited voltage of “about 5 volts” refers to a voltage ranging from 4.5 volts to 5.5 volts.

Droop control is a technique for regulating voltage and frequency of energy sources (or the inverters coupled thereto) by inherently regulating reactive power and active power, which can be sensed locally, based on certain AC droop curves. For example, an inverter controller senses the output voltage of an inverter and controls the output voltage independently based on the AC droop curves. Applying droop control across microgrid sources (e.g., grid-forming inverters) enables synchronization and power sharing among the various energy sources.

However, dissimilar energy sources may respond differently to various grid conditions, such as step changes in load (step load conditions, or step loads for brevity), source impedances, short circuit conditions, and the like. For example, a rate of change of a droop setpoint frequency (ROCOF) in response to a step load may be different for a solar inverter than for a synchronous machine, which inherently includes an inertial component that is not present in the solar inverter. This difference in response to a grid condition (e.g., a step load) may result in circulating power between the energy sources, which may damage the inverter (e.g., by exceeding its rated power) or trigger various remedial measures, such as shutting down or restarting the microgrid. Accordingly, it is useful to control the operation of grid-connected inverters to more closely match the response of other grid-connected sources to a particular grid condition, and thus reduce the presence and amount of circulating power.

One approach to control a grid-connected inverter to reduce the above problems is to emulate the synchronous machine behavior by implementing a rate limiter control to the ROCOF of the inverter. However, emulating the behavior of a particular synchronous machine requires knowing the synchronous machine parameters in advance, which is not always feasible. Also, even if synchronous machine parameters are known in advance, the microgrid may include dissimilar synchronous machines, or other grid-connected sources with different frequency response behavior in response to a particular grid condition. Accordingly, it is difficult to design an inverter to effectively emulate other unknown and/or diverse energy sources.

Embodiments of the present disclosure address the foregoing by providing an adaptive ramp rate controller that applies proportional-integral (PI) control to the droop setpoint frequency during such step load conditions that may demand step changes in inverter frequency as governed by a droop curve.

It can be demonstrated that differentiating the droop setpoint frequency of the inverter provides an accurate estimation of the difference in frequencies between the inverter and the grid (i.e., another grid-connected source in a simple two-source example). As explained above, the objective is to reduce the difference in frequencies between the inverter and the grid, theoretically to zero. Accordingly, an adaptive ramp rate controller is added to the result of differentiating the droop setpoint, and is determined by applying the Pₗ control to the differentiated droop setpoint. Subsequently, the frequency of the inverter is controlled based on a) its initial frequency, b) a pre-defined ramp rate (e.g., conventional rate limiter) and c) the determined adaptive ramp rate. In at least some cases, the frequency of the inverter may be controlled based on applying a conventional rate limiter to the initial frequency, and based on the droop setpoint frequency.

Simulation results demonstrate that the above adaptive ramp rate-based control enables the frequency of the inverter to track the frequency (ies) of other source(s) connected to the grid during step changes in the load/frequency of the grid, until the droop setpoint is reached at steady state. As a result, circulating power is reduced.

In another embodiment, a power control loop may include a droop control loop as an inner control loop (i.e., the power control loop is an outer control loop). Conventionally, the bandwidth of the droop control loop limits the bandwidth of the power control loop. A lower bandwidth for the power control loop may result in decreased transient response (i.e., longer settling times) and increased over/undershoots in response to changes in grid conditions, which is not desirable.

In this embodiment, the power control loop includes an additional Pₗ controller that implements a pre-filter, to reduce the impact of the bandwidth of the droop control loop on the bandwidth of the power control loop. The Pₗ controller includes a zero at Kᵢ/Kₚ, which is matched to the pole of the inner droop control loop at mP₀, where m is the droop curve and P₀ is a system power constant. Cancelling the inner loop pole results in the power control loop bandwidth being independent of the droop control loop bandwidth.

In one embodiment, the power control loop may be applied as a maximum power loop, to limit the active power of the inverter from exceeding its power rating. In another embodiment, the power control loop may also be applied as a negative or minimum power loop, to limit the active power of the inverter from becoming negative (e.g., due to the inability of the inverter to sink power).

Finally, inverters generally cannot sink power, and thus the negative power limit is commonly set to zero. However, this may result in a longer system transient response (e.g., to a load step down) because of the inertia of other grid-connected synchronous machines. An additional embodiment addresses this by providing a resistive load (e.g., a resistor bank) that is coupled to a DC bus of the inverter by an H-bridge circuit. The H-bridge circuit is controlled based on a voltage of the DC bus and a reference voltage, to enable the inverter to sink power in a negative power scenario, which provides additional damping to other grid-connected sources (e.g., synchronous machines) and thus reduces frequency overshoots in response to various changes in grid conditions.

These and other embodiments are described more fully below, with reference made to the accompanying figures.

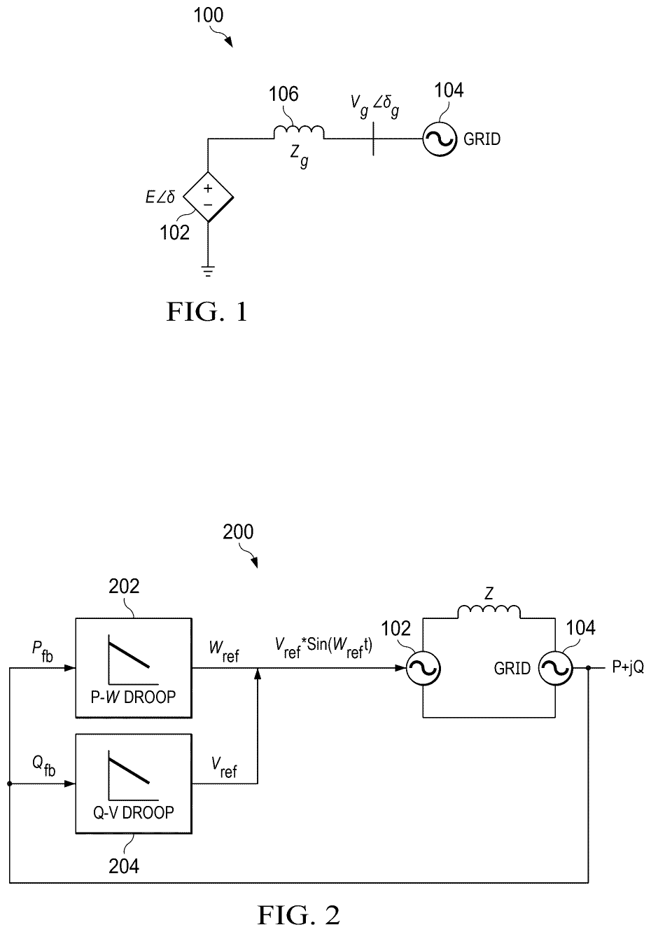

FIG. 1 is a schematic illustration of a circuit model 100 of a grid-forming inverter (also referred to simply as an inverter, for brevity). As explained above, droop control is a technique for synchronization and power sharing in grids and microgrids. Droop control works on the basic principle of power flow between two voltage sources, where the two sources can be a grid-forming inverter and a grid/microgrid formed by a combination of paralleled sources as shown in FIG. 1. In the circuit model 100, the grid-forming inverter is represented by a voltage source 102, while the grid/microgrid (also referred to simply as a grid, for brevity) is represented by an AC voltage source 104. The inverter 102 thus forms a grid/islanded grid by acting as a voltage source connected to the grid/microgrid/load 104 through an impedance 106. The impedance 106 may be grid impedance, source (i.e., inverter) impedance, or a combined impedance of both the grid and the source.

In FIG. 1, E<δ represents the inverter 102 voltage vector, V_{g}<δ_{g} represents grid 104 voltage vector, and Z_{g} is the impedance 106 between the inverter 102 and the grid 104. The active power (P) and reactive power (Q) flow are given by power swing equations:

$$P = \frac{E}{{Z}_{g}} ( E cos θ - {V}_{g} cos ( θ + δ - {δ}_{g} ) ) \qquad Equation 1$$

$$Q = \frac{{V}_{g}}{{Z}_{g}} ( E sin ( θ + δ - {δ}_{g} ) - {V}_{g} sin θ ) \qquad Equation 2$$

In Equations 1 and 2, E is the magnitude of the voltage of the inverter 102 and V_{g} is the magnitude of the voltage of the grid 104, Z_{g} is the magnitude of the impedance 106, 0 is the phase angle of the impedance 106, and δ−δ_{g} represents the phase angle difference between sources.

At the grid level, the impedance 106 is predominantly inductive, and thus the real power and reactive power flow are characterized by the phase and voltage differences, respectively, between the inverter 102 and the grid 104. Assuming that the impedance 106 is predominantly inductive, the active and reactive power exported to grid 104 from Equations 1 and 2 can be rewritten as:

$$P = \frac{E * {V}_{g} sin ( δ - {δ}_{g} ) )}{{X}_{g}} \qquad Equation 3$$

$$Q = \frac{{V}_{g} * ( E cos ( δ - {δ}_{g} ) - {V}_{g} )}{{X}_{g}} \qquad Equation 4$$

In Equations 3 and 4, X_{g} is the reactive component of impedance Z_{g}, because of the predominantly inductive nature of the impedance 106. The power angle (δ−δ_{g}) is a function of frequency difference between the source 102 and the grid 104. For small values of power angle (δ−δ_{g}) Equation 3 can be rewritten as:

$$P = \frac{E * {V}_{g}}{{X}_{g}} * \int ( {ω}_{s} - {ω}_{g} ) dt \qquad Equation 5$$

Where ωₛ and ω_{g} are source and grid frequency, respectively. From Equations 4 and 5, it can be seen that the active power (P) exported to the grid 104 can be controlled by controlling the frequency of the inverter 102 (which indirectly controls the phase), while the reactive power (Q) exported to the grid 104 can be controlled by controlling the voltage of the inverter 102.

FIG. 2 is a schematic illustration of a droop control implementation 200 for a grid-forming inverter. As explained above, grid-forming inverters and synchronous machines typically employ droop control to maintain synchronism with the grid, where the frequency and voltage references of the inverter are derived from active and reactive power feedback, respectively.

A first droop curve 202 is applied to the active power feedback component from the grid 104, and provides a reference frequency (w_{ref}) based on the active power component. A second droop curve 204 is applied to the reactive power feedback component from the grid 104, and provides a reference voltage (v_{ref}) based on the reactive power component. The reference frequency and reference voltage are used to control the behavior of the grid-forming source (e.g., inverter 102).

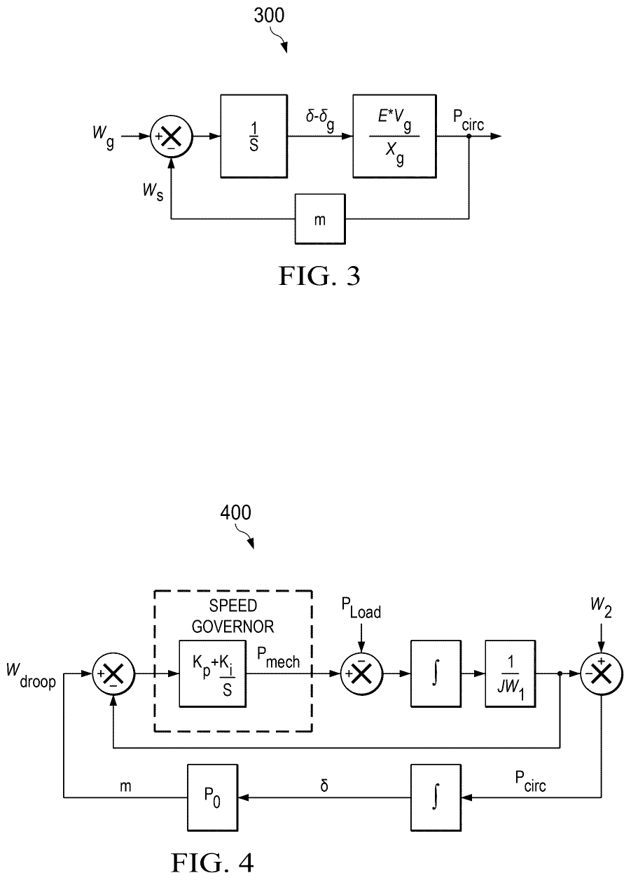

FIG. 3 is a schematic illustration of a closed loop model of droop control implementation 300 for a grid forming inverter. In the closed loop implementation 300 in FIG. 3, the droop curves form a closed loop by providing negative feedback against the change in frequency/phase through circulating power (P_{circ}), or the power exported to the grid by the inverter. The closed loop implementation 300 enables grid-forming sources (e.g., inverter 102) to synchronize with the grid/microgrid while also controlling power as governed by a linear droop equation. Equation 6 shows classical droop equation that governs the frequency versus active power characteristic of a grid forming source:

$$f = {f}_{nl} - m * {P}_{l} \qquad Equation 6$$

Where fₙₗ is the no load frequency of the grid forming source (e.g., inverter 102) and Pₗ is the load power or power export by the inverter 102.

As explained above, a microgrid may involve parallel operation of several dissimilar sources such as synchronous machines, battery inverters, solar inverters, and the like. Each of these sources could behave differently in terms of response to step loads, source impedances, short circuit conditions, and the like. It is thus useful to match performance of various sources in terms of responses to load conditions and frequency behavior, which may reduce the presence and amount of circulating power in the electrical system.

For example, in the case of a step load condition, because the droop equation (i.e., Equation 6) is linear, a step change in frequency is generated during step changes in load power. A synchronous machine has inertia, which prevents the rotor speed of the synchronous machine (and thus its frequency of operation) from changing abruptly.

However, inverters have no such limitations for frequency of operation and can handle step changes in frequency of operation with a high ROCOF. These differences in frequency response to step changes in load will result in momentary differences in frequency of operation when inverter(s) and synchronous machine(s) are operated in parallel.

These differences in frequency response will also result in circulating power as given by Equation 5. Also, such circulating power may overload some of the sources, or feed power from one source to another source, which could cause a DC bus overshoot. Accordingly, it is useful to match the frequency responses of the various sources that operate in parallel (e.g., an inverter and a synchronous machine) to avoid or reduce such circulating currents during load transients. It may also be useful to avoid a relatively high dF/dT, which might result in a motor load drawing inrush currents, as well as load tripping conditions due to ROCOF.

To avoid high dF/dT and ROCOF trips, inverter-based sources typically employ low-pass filters (LPFs) or frequency rate controllers (e.g., ramp controllers) on a droop curve output, so as to limit the dF/dT of operation.

As explained, energy sources may respond differently to a step load condition in terms of frequency response, which may result in circulating power between the sources. The following example explains the behavior of different sources, such as synchronous machines and inverters, in response to a step load.

Synchronous machines have inherent inertia provided by the rotor shaft that prevents any step changes in frequency in response to step changes in load. The relation between the load power and machine frequency is given by:

$${P}_{m} - {P}_{l} = J ω \frac{d ω}{dt} \qquad Equation 7$$

where Pₘ and Pₗ are shaft mechanical input power and load power, respectively. J is the mechanical inertia and ω is the rotor speed in radians/sec. Pₘ can be considered constant momentarily, because mechanical time constants are typically much higher than electrical time constants. J may be expressed in terms of an inertia constant H

$$( where H = \frac{\frac{1}{2} \int J {ω}^{2}}{VA Rating} ) .$$

Accordingly, any step load change in Pₗ will initially create a ramp kind of response in the speed/frequency of the synchronous machine, until a speed governor of the synchronous machine responds and adjusts the shaft mechanical power to match the frequency setpoint. Equation 7 may be rewritten as:

$$\int \frac{{P}_{m} - {P}_{l}}{J ω} = ω \qquad Equation 8$$

By considering Pₘ and ω constant momentarily, equation 8 can be translated as:

$$\frac{1}{J ω} \int Δ {P}_{l} = ω \qquad Equation 9$$

Accordingly, for step changes in Pₗ, the synchronous machine initial response in ω appears to ramp with a rate of

$$\frac{Δ {P}_{l}}{J ω} rad / sec .$$

FIG. 4 is a schematic illustration of a closed loop model frequency control implementation 400 for a synchronous generator.

As explained, inverters often employ low-pass filters or a frequency ramp controller to control or otherwise limit the dF/dt during load transients (e.g., step load conditions). The frequency output of a droop curve is passed through such dF/dt limiters before setting the operating frequency of the inverter.

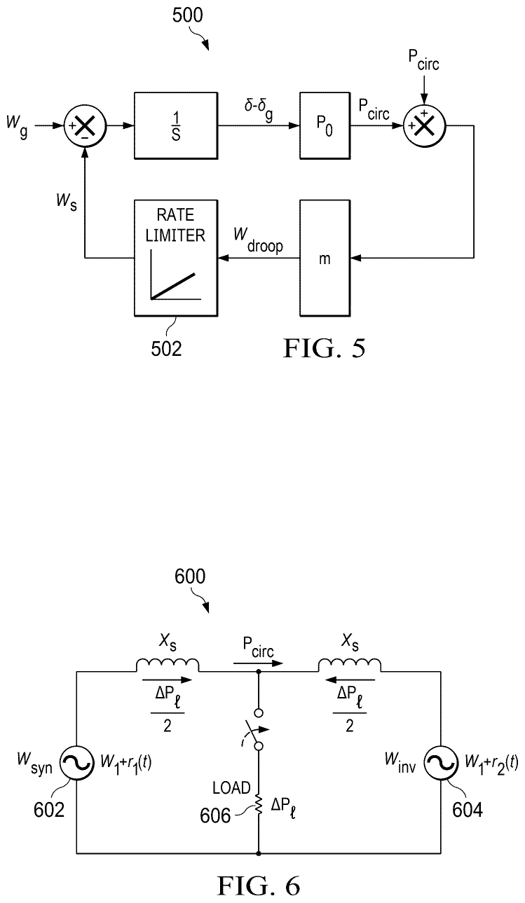

FIG. 5 is a schematic illustration of a closed loop model droop control implementation 500 with a rate limiter for a grid-forming inverter. The droop control implementation 500 is similar to that shown in FIG. 3, but is modified by the addition of a rate limiter 502 that receives the output of the droop curve block (m). As a result, the rate of change of the operating frequency of the inverter is limited accordingly. In FIG. 5, the circulating power constant

$$\frac{E * {V}_{g}}{{X}_{g}}$$

is replaced by P₀ for brevity, and P₀ will be used throughout the following description.

FIG. 6 is a schematic illustration of a circuit model for a system 600 that schematically illustrates a two-source parallel operation in response to a step load condition. In FIG. 6, a synchronous generator 602 and an inverter 604 (together, sources 602, 604) are represented by voltage sources. The synchronous generator 602 and the inverter 604 operate in parallel, and are connected to a load 606.

For simplicity, it is assumed that impedances of the source 602, 604 are matched, and both the sources 602, 604 have same ratings (e.g., kilovolt-ampere (kVA) ratings). Because the capacities of both sources 602, 604 are the same, their droop curve settings will also be similar. Because the impedances of both sources 602, 604 are matched and the droop curves are the same, the load sharing under steady state will be equal, and any step changes in load 606 will result in both sources 602, 604 sharing the step load equally immediately after the step load occurs. This step load causes a step change in frequency setpoints of the droop curve.

It should be understood that if the frequency responses of the sources 602, 604 are not matched, a frequency drift will exist between the sources 602, 604. For example, let r₁(t) and r₂(t) be the rates at which the sources 602, 604 start ramping towards the droop setpoint where both r₁ and r₂ are functions of time, and are not necessarily fixed ramps or low-pass filters.

Additionally, let ω1 be the initial steady state operating frequency corresponding to a steady state operating power of P₁, which is the operating power for both the synchronous generator 602 and the inverter 604, because they share load 606 equally. Let ΔPₗ be the step load applied on the system 600, which is shared equally by the sources 602, 604 as the source impedances (Xₛ) are the same. The step load generates a new frequency setpoint ω₂, to which the synchronous generator 602 and inverter 604 respond by changing their frequencies at the rates of r₁(t) and r₂(t) respectively.

The difference in frequencies created by the different ramp rates of the sources 602, 604 creates a circulating power given by:

$${P}_{circ} = {P}_{0} * \int ( {ω}_{syn} - {ω}_{inv} ) dt \qquad Equation 10$$

Substituting ω_{syn}=ω₁+r₁(t) and ωᵢₙᵥ=ω₁+r₂(t):

$${P}_{circ} = {P}_{0} * \int ( {r}_{1} ( t ) - {r}_{2} ( t ) ) dt \qquad Equation 11$$

As explained above, P₀ is the power transfer constant given by

$${P}_{0} = \frac{E * {V}_{g}}{2 * {X}_{g}}$$

(where E and V_{g} are the source voltages of generator 602 and inverter 604, respectively). Because the droop setpoints for respective sources cannot be met immediately (e.g., to limit the ROCOF), the changes in frequencies caused by different ramp rates creates a circulating power given by Equation 11, and this circulating power will settle only when the final droop setpoints are met.

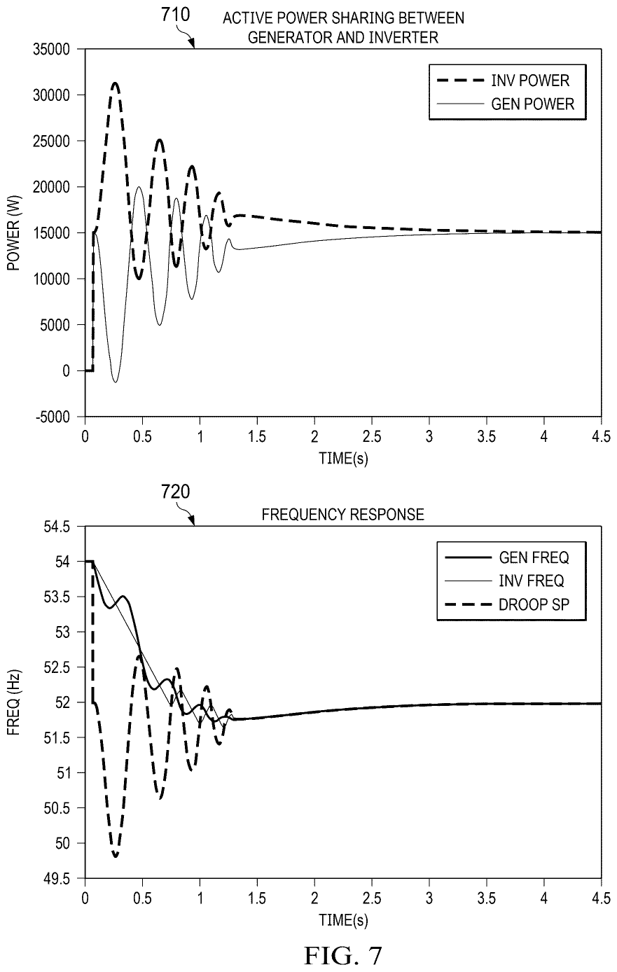

FIG. 7 is a graphical illustration of active power and frequency responses of the synchronous generator 602 and the inverter 604 of FIG. 6 in response to a step load condition. In particular, FIG. 7 shows a first graph 710 of active power of the system 600 as a function of time, and a second graph 720 of frequency response of the system 600 as a function of time, each based on the following parameters:

| Parameter | Value | |
|---|---|---|
| No load frequency (fₙₗ) | 54 | Hz |
| Full load frequency (f_{fl}) | 50 | Hz |
| Step load applied ΔPₗ | 1 | pu |
| Source Impedance (Xₛ) | 0.2 | pu |
| Source Power Rating (S_{rated}) | 30 | kVA |
| Generator Inertia Constant (H) | 0.5 | sec. |
| Generator Initial Ramp rate (r₁(t)) | 3.75 | Hz/sec. |
| Inverter Ramp rate (r₂(t)) | 3 | Hz/sec. |

The simulation presents results when a step load of 30 kilowatts (kW) is applied on the generator and inverter parallel system in which both generator and inverter are rated for 30 kVA with equal impedance of 0.2 per unit (pu). The graph 710 shows that the initial power sharing of the sources 602, 604 (e.g., at the instant of application of the step load) is the same (i.e., 15 kW), because the sources 602, 604 have similar impedance, which results in their droop setpoint going from no load frequency (54 Hz) to 52 Hz. In other words, in this example, 52 Hz is the frequency setpoint that corresponds to a 15 kW load.

The initial frequency ramp rate (df/dt) of the synchronous generator 602 can be calculated as 3.75 Hz/sec. from the inertia constant of the synchronous generator 602 (0.5 sec.). The inverter 604 ramp rate (3 Hz/sec.) is slower than that of the synchronous generator 602, and thus the synchronous generator 602 frequency drops at a faster rate compared to that of the inverter 604, which results the inverter 604 frequency being greater than that of the synchronous generator 602. This frequency mismatch between sources 602, 604 results in circulating power between inverter 604 and synchronous generator 602, while the net power remains constant as the load power remains constant. In the simulation depicted in FIG. 7, the inverter 604 shares a higher amount of load 606 power initially due to its frequency being greater than that of the synchronous generator 602. The power oscillates for a time, and gradually damps down once the operating frequency meets the droop setpoint.

This circulating power during step loads is detrimental to the microgrid reliability, because circulating power could drive the sources 602, 604 to overload or negative power. For example, in FIG. 7, the synchronous generator 602 is subjected to a negative power condition following the step load. These conditions may eventually trip the sources 602, 604 and result in microgrid collapse.

In some cases, the inverter 604 may be controlled in such a manner that it attempts to emulate the synchronous generator 602 behavior by implementing a rate limiter control to the ROCOF of the inverter 604. Damping elements (e.g., resistive load banks) may also be used to sink additional power to reduce the oscillations shown in FIG. 7. However, emulating the behavior of a particular synchronous machine is difficult to achieve in practice, as explained above.

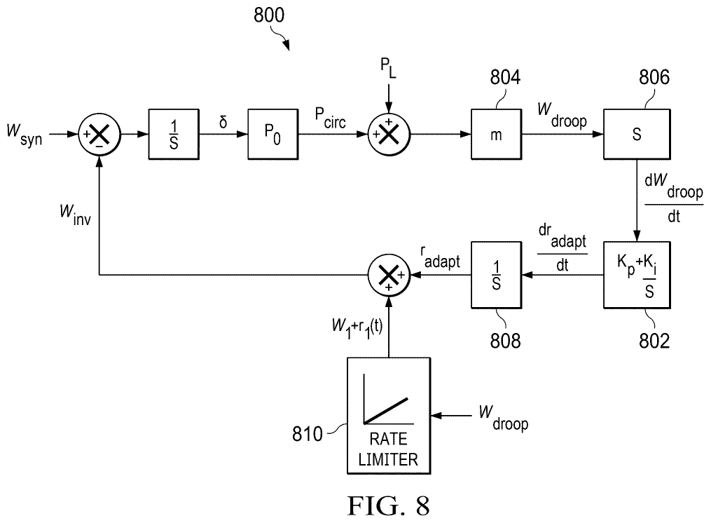

FIG. 8 is a schematic illustration of a closed loop model of droop control with an adaptive ramp control loop 800 for a grid-forming inverter in accordance with an embodiment of the present disclosure. As explained, it is difficult to match frequency response of different sources to step loads or load transient conditions through emulated models and particularly-selected ramp rates. Accordingly, in at least some embodiments described herein, an adaptive ramp controller adaptively controls a frequency of an inverter to match that of another connected source (or grid/microgrid).

The power sharing example of FIG. 6 demonstrates that the power sharing of each source (e.g., sources 602, 604) after a step load can be given as:

$${P}_{syn} = \frac{Δ {P}_{l}}{2} + {P}_{circ} \qquad Equation 12$$

$${P}_{inv} = \frac{Δ {P}_{l}}{2} - {P}_{circ} \qquad Equation 13$$

In the example of FIG. 6, the load 606 is constant, and thus summing Equations 12 and 13 gives the total power as ΔPₗ, which verifies the power balance. The droop setpoint of the inverter 604 can be given as:

$${f}_{droop}^{inv} = {f}_{nl} - m * {P}_{inv} \qquad Equation 14$$

Substituting Equation 13 into Equation 14 gives:

$${f}_{droop}^{inv} = {f}_{nl} - m * \frac{Δ {P}_{l}}{2} - {P}_{circ} \qquad Equation 15$$

Differentiating Equation 15 gives:

$$\frac{{df}_{droop}^{inv}}{dt} = \frac{{df}_{nl}}{dt} - m * \frac{d Δ {P}_{l}}{2 dt} - m * \frac{{dP}_{circ}}{dt} \qquad Equation 16$$

Because fₙₗ is a constant, and the load is constant after the step load condition, Equation 16 can be simplified as:

$$\frac{{df}_{droop}^{inv}}{dt} = - m * \frac{{dP}_{circ}}{dt} \qquad Equation 17$$

Substituting Equation 10 into Equation 17

$$\frac{{df}_{droop}^{inv}}{dt} = - {mP}_{0} \frac{d}{dt} ( \int ( {ω}_{syn} - {ω}_{inv} ) dt ) \qquad Equation 18$$

$$\frac{{df}_{inv}^{sp}}{dt} = - {mP}_{0} * ( {ω}_{syn} - {ω}_{inv} )$$

From Equation 18, it can be seen that the differentiation of droop setpoint frequency of the inverter 604 gives the difference in the frequencies between the sources 602, 604. Reducing this difference in frequency (ideally to zero) correspondingly reduces (or eliminates) circulating power, which is one object of the present disclosure. To facilitate reducing the difference in frequency, the frequency of operation of the inverter 604 during the frequency ramp may be modified to add a correction term:

$${ω}_{inv} = {ω}_{1} + {r}_{2} ( t ) + {r}_{adap} ( t ) \qquad Equation 19$$

Where the correction term is added as an adaptive ramp rate given by:

$$\frac{{dr}_{adap} ( t )}{dt} = {K}_{P} \frac{{df}_{droop}^{inv}}{dt} + {K}_{i} * \int \frac{{df}_{droop}^{inv}}{dt} \qquad Equation 20$$

Because ω_{syn}=ω₁+r₁(t), the difference in frequencies between synchronous generator 602 and inverter 604 can be given as:

$${ω}_{syn} - {ω}_{inv} = {r}_{1} ( t ) - {r}_{2} ( τ ) + {r}_{adap} ( τ ) \qquad Equation 21$$

Substituting Equation 20 into Equation 21 gives:

$${ω}_{syn} - {ω}_{inv} = {r}_{1} ( t ) - {r}_{2} ( t ) + \int ( {K}_{P} \frac{{df}_{inv}^{sp}}{dt} + {K}_{i} * \int \frac{{df}_{inv}^{sp}}{dt} ) dt \qquad Equation 22$$

Substituting Equation 18 into Equation 22 gives:

$${ω}_{syn} - {ω}_{inv} = {r}_{1} ( t ) - {r}_{2} ( t ) - {mP}_{0} * [ \int \{ ( {K}_{P} ( {ω}_{syn} - {ω}_{inv} ) + \int {K}_{i} ( {ω}_{s y n} - {ω}_{inv} ) dt ) \} dt ] \qquad Equation 23$$

Taking (ω_{syn}−ωᵢₙᵥ)=ω_{diff}, Equation 23 can be rewritten as:

$${ω}_{diff} = {r}_{1} ( t ) - {r}_{2} ( t ) - {mP}_{0} * [ \int \{ {K}_{P} {ω}_{diff} + \int {K}_{i} {ω}_{diff} dt ) \} dt ] \qquad Equation 24$$

Applying Laplace transforms to both sides of Equation 24 gives:

$${ω}_{diff} ( s ) = {r}_{1} ( s ) - {r}_{2} ( s ) - {K}_{p} * m * {P}_{0} * \frac{{ω}_{diff} ( s )}{s} - {K}_{i} * m * {P}_{0} * \frac{{ω}_{diff} ( s )}{{s}^{2}} \qquad Equation 25$$

Equation 25 can be rearranged as:

$${ω}_{diff} ( s ) ( {s}^{2} + m * {K}_{p} {P}_{0} s + m * {K}_{i} {P}_{0} ) = ( {r}_{1} ( s ) - {r}_{2} ( s ) ) * {s}^{2} \qquad Equation 26$$

$${ω}_{diff} ( s ) = \frac{( {r}_{1} ( s ) - {r}_{2} ( s ) ) * {s}^{2}}{( {s}^{2} + m * {K}_{p} {P}_{0} s + m * {K}_{i} {P}_{0} )} \qquad Equation 27$$

From Equation 27, the difference in the frequencies of sources (i.e., ω_{diff}) represents a second-order system. For any ramp functions r₁(s)/r₂ (s) up to the order of two (e.g., a low-pass filter is a first-order function, a ramp function is a second-order function), the steady state error in ω_{diff}(s) is given by:

$${lim}_{s \to 0} s * {ω}_{diff} ( s ) = \frac{( {r}_{1} ( s ) - {r}_{2} ( s ) ) * {s}^{3}}{( {s}^{2} + m * {K}_{p} {P}_{0} s + m * {K}_{i} {P}_{0} )} \qquad Equation 28$$

For r₁(s) and r₂ (s) in the form

$$\frac{k}{( {s}^{2} + as + b )}$$

(where k, a, b ≥0) Equation 28→0 results in ω_{diff}→0, which corresponds to the frequencies being matched between the sources 602, 604. For example, let r₁(t) and r₂(t) be two ramp functions with slopes k₁ and k₂, respectively:

$${r}_{1} ( t ) = {k}_{1} t ⇒ {r}_{1} ( s ) = \frac{{k}_{1}}{{s}^{2}} \qquad Equation 29$$

$${r}_{2} ( t ) = {k}_{2} t ⇒ {r}_{2} ( s ) = \frac{{k}_{2}}{{s}^{2}} \qquad Equation 30$$

Substituting Equations 29 and 30 into Equation 28 for a steady state error in ω_{diff} gives:

$${lim}_{s \to 0} s * {ω}_{diff} ( s ) = \frac{( \frac{{k}_{1} {k}_{2}}{{s}^{2} {s}^{2}} ) * {s}^{3}}{( {s}^{2} + m * {K}_{p} {P}_{0} s + m * {K}_{i} {P}_{0} )} \qquad Equation 31$$

$${lim}_{s \to 0} s * {ω}_{diff} ( s ) = \frac{( {k}_{1} - {k}_{2} ) * s}{( {s}^{2} + m * {K}_{p} {P}_{0} s + m * {K}_{i} {P}_{0} )}$$

$${lim}_{s \to 0} s * {ω}_{diff} ( s ) = \frac{( {k}_{1} - {k}_{2} ) * 0}{( m * {K}_{i} {P}_{0} )}$$

$${lim}_{s \to 0} s * {ω}_{diff} ( s ) = 0$$

In some situations, a ramp function is an example of a relatively difficult second-order response to track, particularly when its slope is greater. From Equation 31, it can be seen that as ω_{diff}→0 the frequency of inverter 604 will track the frequency of the synchronous generator 602 (or other source) through the ramp until the droop setpoint is reached at steady state. The bandwidth of the control loop 800 for the inverter 604 is ωₙ=\sqrt{Kᵢ*m*P₀}, and the damping factor of the control loop 800 for the inverter 604 is

$$ε = \frac{{K}_{p} * m * {P}_{0}}{2 * {ω}_{n}} .$$

Accordingly, desired bandwidth and damping factor values for the control loop 800 can be achieved by selecting the values of Ki and Kp.

As explained above, the control loop 800 applies proportional-integral (PI) controller 802 to the droop set point frequency determined by the droop curve 804. In this example, the droop set point frequency is differentiated at block 806, which provides an accurate estimation of the difference in frequencies between the inverter 604 and the grid (i.e., another grid-connected source, such as synchronous generator 602 in the simple two-source example of FIG. 6) as demonstrated in Equation 18.

As explained above, an objective is to reduce the difference in frequencies (ω_{syn}−wᵢₙᵥ), theoretically to zero. Accordingly, the Pₗ controller 802 is added or applied to the result of differentiating the droop set point, which results in an adaptive ramp rate. In the specific example of FIG. 8, the output of the Pₗ controller 802 is a derivative of the adaptive ramp rate, and thus block 808 integrates the output of the Pₗ controller 802 to provide the adaptive ramp rate. Subsequently, the frequency of the inverter 604 is controlled based on a) its initial frequency, b) a pre-defined ramp rate (e.g., conventional rate limiter 810) and c) the determined adaptive ramp rate. In at least some cases, the frequency of the inverter 604 may be controlled based on applying a conventional rate limiter to the initial frequency, and based on the droop set point frequency.

In at least one example embodiment, a method may thus include controlling an inverter (e.g., inverter 604) to operate at an initial frequency (ω₁). As explained above, the inverter 604 is connected to a load 606 and a source, such as a fuel cell, solar panels, or the like. The method may also include sensing a load power (e.g., Pₗ, provided to the adaptive ramp rate control loop 800), and generating a droop set point frequency in response to a change in the load power. For example, the droop curve 804 in the adaptive ramp rate control loop 800 generates ωdroop based on Pₗ . . .

The method also includes applying a first proportional gain constant and a first integral gain constant (e.g., by Pₗ controller 802) to a rate of change of the droop set point frequency to generate an adaptive ramp rate. For example, the droop set point frequency may be differentiated at block 806 to generate a rate of change thereof. The Pₗ controller 802 may generate an output that, when subsequently integrated (e.g., by block 808) is the adaptive ramp rate (r_{adapt}). The method further includes controlling a frequency of the inverter 604 based on the initial frequency and the adaptive ramp rate. For example, as shown in FIG. 8, ωᵢₙᵥ=ω₁+r₁(t)+r_{adapt}.

In FIG. 8 and methods related thereto, a difference between the frequency of the inverter 604 and the frequency of another power source (e.g., synchronous generator 602) in response to the step load condition is reduced by generating the adaptive ramp rate, and controlling the frequency of the inverter 604 based on the adaptive ramp rate.

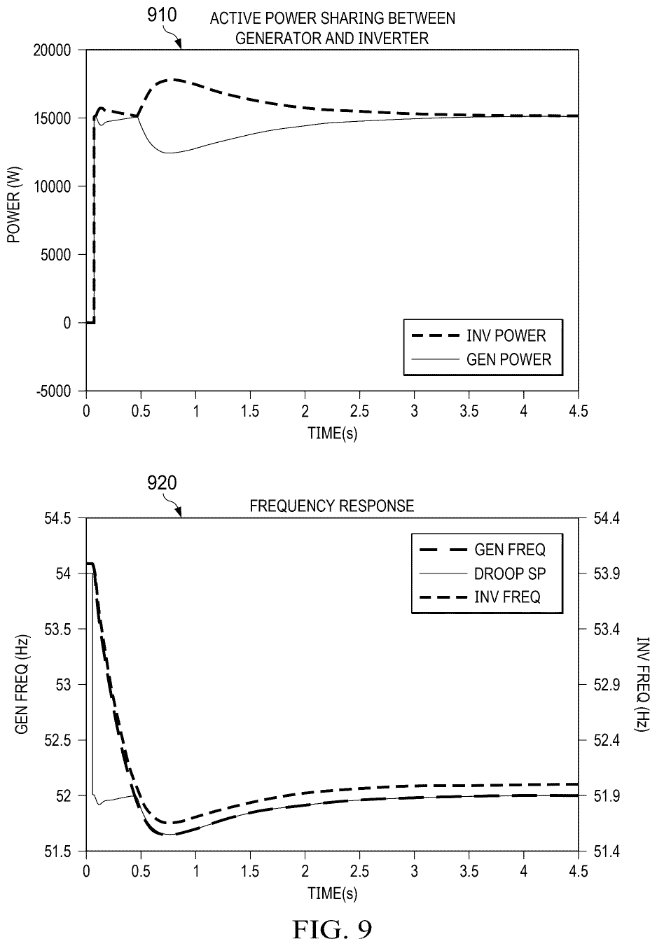

FIG. 9 is a graphical illustration of active power and frequency responses of the synchronous generator 602 and the inverter 604 of FIG. 6 in response to a step load condition, in which the inverter 604 implements closed loop droop control with the adaptive ramp rate control loop 800 of FIG. 8 in accordance with an embodiment of the present disclosure. In particular, FIG. 9 shows a first graph 910 of active power of the system 600 as a function of time, and a second graph 920 of frequency response of the system 600 as a function of time, each based on the same parameters as were applied in the example of FIG. 7, described above. The second graph 920 includes split frequency axes with the left y-axis representing generator frequency, and the right y-axis representing inverter frequency.

The graph 910 illustrates that the response of both the synchronous generator 602 and the inverter 604 to the step load condition is relatively smooth, with the active power of both sources 602, 604 remaining relatively close to the initial shared value of 15 kW. The frequency response illustrated in graph 920 shows the frequency of the inverter 604 tracking the frequency of the synchronous generator 602 (e.g., the right y-axis is offset by 0.1 Hz from the left y-axis, and the inverter frequency is offset from the generator frequency by approximately the same amount). The droop setpoint also remains relatively close to 52 Hz. The deviations of power and frequency that occur around 0.5 seconds in the graphs 910, 920 are in response to the synchronous generator 602 frequency dropping below its setpoint of 52 Hz. This is due to an undershoot of governor response, which takes the synchronous generator 602 frequency below the setpoint. During this period (e.g., after about 0.5 seconds), the inverter 604 provides additional power, which prevents the synchronous generator 602 frequency from falling further.

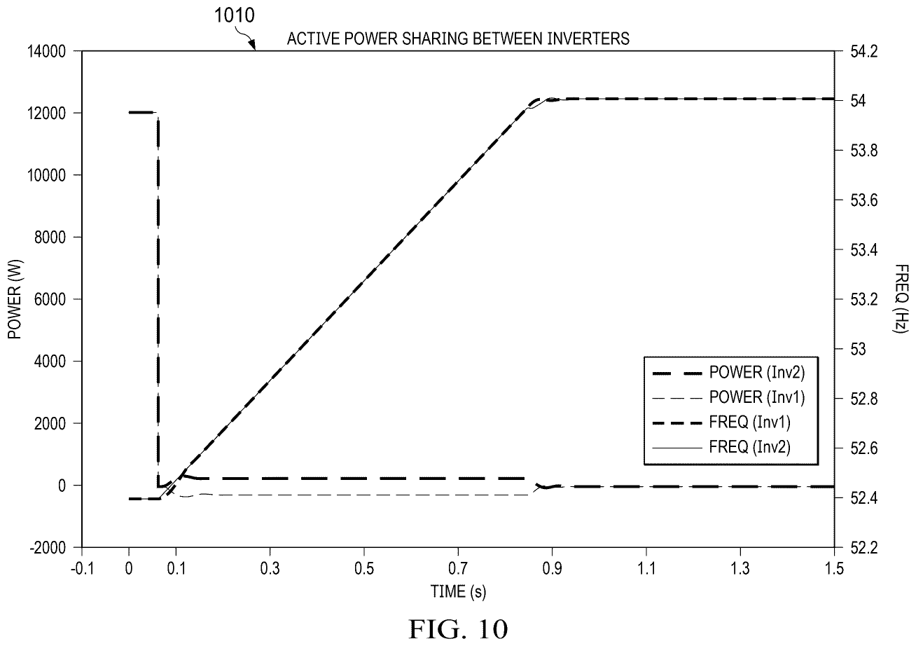

FIG. 10 is a graphical illustration of active power and frequency responses of two grid-forming inverters in response to a step down load condition, in which one of the inverters (Inv2) implements closed loop droop control with the adaptive ramp rate control loop 800 of FIG. 8 in accordance with an embodiment of the present disclosure. The other inverter (Inv1) implements a ramp rate controller, but without the adaptive ramp rate portions of FIG. 8; that is, the other inverter (Inv1) is generally conventional.

In particular, FIG. 10 shows a graph 1010 of active power and frequency of the exemplary two-inverter system as a function of time. In the example of FIG. 10, the simulation presents results when a step down in load from 24 kilowatts (kW) to 0 kW. The other parameters such as source ratings, impedances, droop setpoints are the same as discussed above with respect to FIGS. 7 and 9. The ramp rate (r₁(t)) of Inv1 is set to 4 Hz/sec., while the inverter Inv2 has a ramp rate setpoint (r₂(t)) of 3 Hz/sec. Both inverters share the load equally (i.e., 12 kW each) in steady state before the step down in load is applied.

In addition to the adaptive ramp control loop 800 described above, other embodiments of this disclosure may be directed to various power control loops that improve (e.g., increase) a bandwidth of the control loop relative to conventional approaches.

For example, the power ratings or the energy capacities of multiple sources connected in a microgrid may vary based on the requirement(s) and choice(s) of the microgrid operator. The mismatches in power ratings and the disparate nature of energy conversion devices such as synchronous machines, inverters, and the like cause the impedance of the sources to vary. During step load conditions, such mismatched impedances may overload one or more sources and/or feed power from one source to other (e.g., as circulating power). For example, a synchronous machine (generator) with a higher power rating than an inverter may have approximately the same value of source impedance.

In this example, a step load may result in both the sources sharing the power equally because their impedances are matched. Accordingly, the inverter (having a much lower power rating than the generator) ends up sharing the same amount of load, which may drive the inverter into overload. Similarly, a step down in load may result in the generator feeding power into the inverter because the generator may be at a higher phase angle prior to the step down so as to deliver a higher amount of power. Also, short circuit conditions may cause the frequencies and phases of connected sources to drift apart from each other, which can also result in overload or reverse power conditions upon rectification of the short circuit condition. Accordingly, it is useful to provide power loop controller(s) to limit power in both directions (e.g., a maximum power control loop and a minimum (or sometimes negative) power control loop) to protect the microgrid sources.

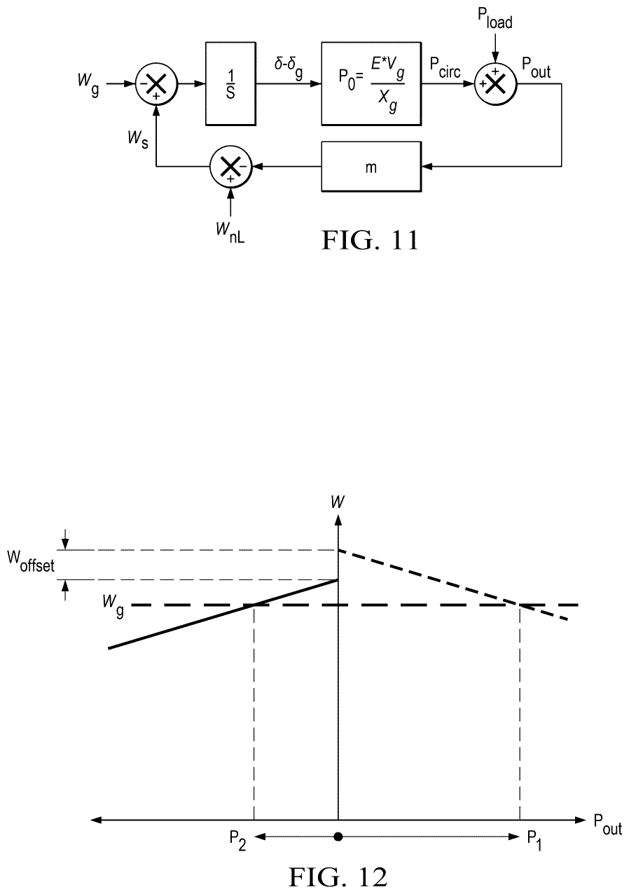

FIG. 3, described above, illustrates a closed loop droop control implementation. FIG. 11 is a schematic illustration of a closed loop droop control implementation that models load disturbances and droop curve offset. In FIG. 11, the sign conventions for ω_{g} and ωₛ are changed relative to FIG. 3, which changes the signs of P_{circ} accordingly to incorporate no load frequency (ωₙₗ). However, the effective closed loop transfer function remains the same. For example, it can be observed from FIG. 11 that the transfer functions of output power (Pₒᵤₜ) with respect to the no load frequency and grid frequency are similar, and can be given as:

$$\frac{{P}_{out} ( s )}{{ω}_{g} ( s )} = \frac{{P}_{out} ( s )}{{ω}_{nL} ( s )} = \frac{{P}_{0}}{s + {mP}_{0}} \qquad Equation 32$$

Thus, the output power varies as a function of both the grid/microgrid frequency and the no load frequency and can be controlled by varying either one of those frequencies. Because the microgrid frequency is not necessarily controllable by any one source, it is relatively more straightforward to control the no load frequency of the droop curve.

FIG. 12 is a graphical illustration of power control through droop curve offset adjustment. It should be appreciated that the output power corresponds to the intersection point of the grid/microgrid frequency (ω_{g}) and the droop curve. For example, in FIG. 12, the output power changes from P1 to P2 when the droop curve offset is changed. This fundamental property of droop curve control may be used to control the output power of grid-connected voltage sources, such as synchronous generators, inverters, and the like.

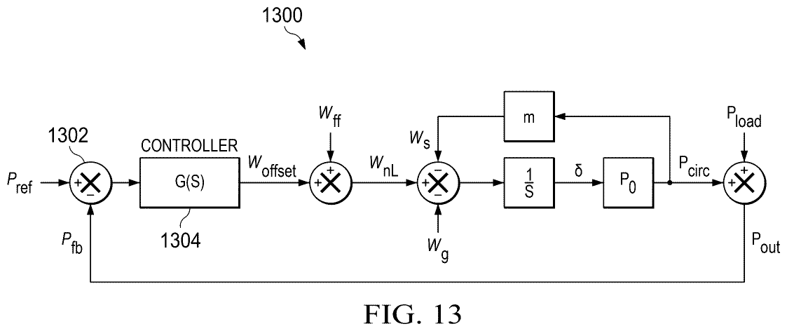

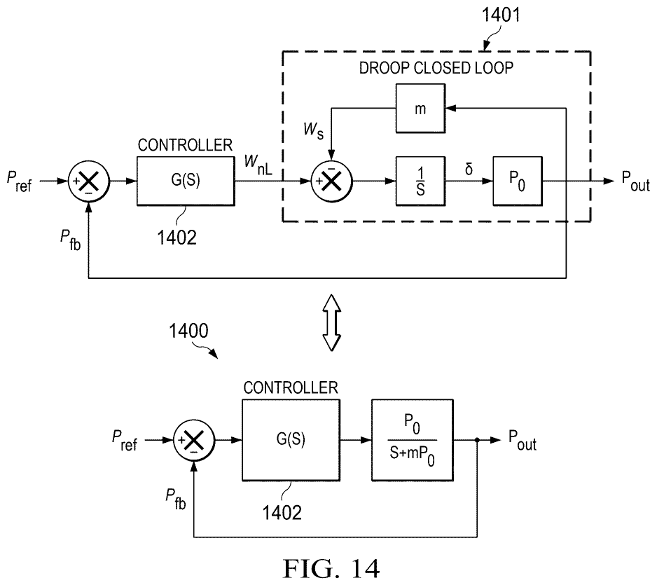

FIG. 13 is a schematic illustration of a model of a power control loop 1300 that employs offset control in accordance with an embodiment of the present disclosure. In FIG. 13, the error of the power control loop 1300 is provided by an error amplifier 1302 based on a reference power (P_{ref}) and the output power (Pₒᵤₜ), which is also the closed loop feedback power (P_{fb}). The error is provided to a controller 1304 G(s) (e.g., a PI controller), which provides an offset to shift the no load frequency of the droop curve from the default no load frequency, which is provided as a feed forward frequency (ω_{ff}). The control loop 1300 effectively sets the no load frequency of the droop curve, thereby controlling the output power. By neglecting the disturbances in the block diagram of FIG. 13, such as ω_{ff}, ω_{g}, and P_{load}, the block diagram can be simplified as shown in FIG. 14.

Thus, FIG. 14 is a schematic illustration of a simplified power control loop 1400 in accordance with an embodiment of the present disclosure. FIG. 14 illustrates that the droop control loop 1401 forms an inner loop of the simplified power control loop 1400, which is thus an outer loop 1400. The bandwidth of the inner droop control loop 1401, as observed from Equation 32, is mP₀. In some cases, a designer selects the bandwidth of an outer loop (e.g., the simplified power control loop 1400) to be 1 decade before (i.e., 1/10) the bandwidth of the inner loop 1401, which would limit the bandwidth of the outer loop to

$$\frac{{mP}_{0}}{10} .$$

A lower droop slope value (m) may be desired to provide improved frequency regulation (such as 0.1-0.3 Hz droop). However, a relatively lower droop slope value results in a correspondingly lower bandwidth for the power control loop, which may result in poor transient response and high over/undershoots during disturbances. Even in cases in which the outer loop 1400 bandwidth is selected to be

$$> \frac{{mP}_{0}}{10} ,$$

because the inner loop 1401 bandwidth is limited to mP₀, this becomes a dominant pole that restricts the bandwidth of the outer loop 1400. A lower bandwidth for the power control loop 1400 may result in decreased transient response (i.e., longer settling times) and increased over/undershoots in response to changes in grid conditions, which is not desirable.

In the example of FIG. 14, the bandwidth of the power control loop 1400 is limited by the pole/bandwidth of the inner droop control loop 1401. Accordingly, in an embodiment of the present disclosure, a PI controller 1402 is added that is designed to cancel out the pole of the inner droop control loop 1401, and thus acts as a pre-filter to achieve a higher bandwidth for the overall power control loop 1400 that is independent of the pole location of the inner droop control loop 1401. In other words, the limitations on bandwidth that are imposed by the pole of the inner droop control loop 1401 are mitigated by including the PI controller 1402. For example, it is assumed that the controller 1402 (i.e., G(s)) is a PI controller having the transfer function:

$$G ( s ) = \frac{{sK}_{p} + {K}_{i}}{s} \qquad Equation 33$$

where Kₚ and Kᵢ are the proportional and integral gain constants, respectively, of the controller 1402. The PI controller 1402 transfer function has a zero located at

$$\frac{{K}_{i}}{{K}_{p}}$$

radians (rad)/sec and a pole at 0 rad/sec. If the location of the zero of the PI controller 1402 is matched with the location of the pole of the inner loop 1401 (i.e., mP₀), then the zero of the controller 1402 effectively cancels out the pole of the inner loop 1401, giving the open loop transfer function as:

$$\frac{{P}_{out} ( s )}{err ( s )} = \frac{{K}_{p} ( s + \frac{{K}_{i}}{{K}_{p}} )}{s} * \frac{{P}_{0}}{s + {mP}_{0}} \qquad Equation 34$$

For

$$\frac{{K}_{i}}{{K}_{p}} = {mP}_{0} ,$$

the zero of the PI controller 1402 acts as a prefilter cancelling out the pole of the inner droop control loop 1401:

$$\frac{{P}_{out} ( s )}{err ( s )} = \frac{{K}_{p} {P}_{0}}{s} \qquad Equation 35$$

Accordingly, the closed loop transfer function of the power control loop 1400 can be given as:

$$\frac{{P}_{out} ( s )}{{P}_{ref} ( s )} = \frac{{K}_{p} {P}_{0}}{s + {K}_{p} {P}_{0}} \qquad Equation 36$$

Equation 36 represents a first-order system whose bandwidth is given by ωn=KₚP₀. Accordingly, by selecting the value of Kₚ with Kᵢ=mKₚP₀, any desired bandwidth can be achieved for the power control loop 1400, which will be independent of the bandwidth of the droop (inner) control loop 1401. This enables the power control loop 1400 to achieve a sufficiently high bandwidth, which in turn enables limiting the power of a microgrid source during various conditions.

In at least one example embodiment, a method may thus include sensing an output power of an inverter (e.g., inverter 604). As explained above, the inverter 604 is connected to a load 606 and a source, such as a fuel cell, solar panels, or the like. The method may also include applying a droop curve (e.g., block m in the droop control loop 1401) to the output power of the inverter to generate a droop set point frequency in response to the output power.

The method also includes generating a no load frequency by applying a second proportional gain constant and a second integral gain constant (e.g., by PI controller 1402) to a difference between the output power of the inverter and a reference power (P_{ref} in FIG. 14). As explained above, Kᵢ=mKₚP₀, where P₀ is a system power constant. By selecting the values of the proportional and integral gain constants according to this relationship, as well applying the transfer function according to Equation 33 (e.g., by the PI controller 1402), the method enables achieving a relatively high bandwidth (or any desired bandwidth) while controlling the inverter output power.

The embodiment described with respect to FIG. 14 may be applied to achieve high-bandwidth power control loops in various contexts, such as a maximum power control loop (e.g., to limit the active power of the inverter from exceeding its power rating, or a maximum threshold value), a negative or minimum power control loop (e.g., to limit the active power of the inverter from becoming negative or falling below a minimum threshold value), or a DC bus limiting control loop (e.g., to avoid a DC bus voltage of the inverter from falling below a minimum threshold value).

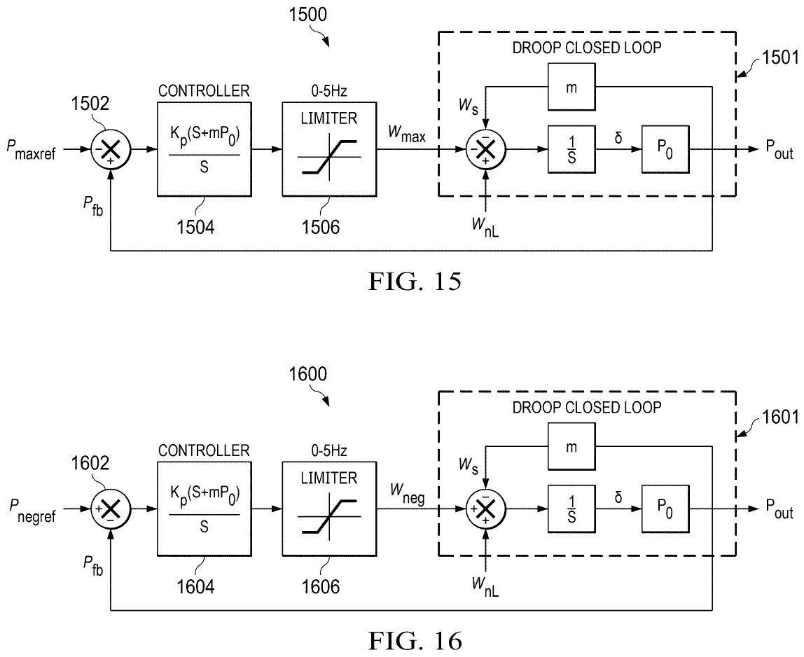

FIG. 15 is a schematic illustration of a maximum power control loop 1500 in accordance with an embodiment of the present disclosure. The maximum power control loop 1500 limits the active power of an inverter from exceeding the power rating of the inverter (P_{maxref}) during an overload condition. In the example of FIG. 15, the loop reference is P_{maxref}, which is provided as an input to a negative terminal of error amplifier block 1502. The output of error amplifier block 1502 is provided to PI controller 1504, which applies the transfer function of PI controller 1402, explained above with respect to FIG. 14. In other words, a zero of PI controller 1504 acts as a prefilter cancelling out the pole of the inner droop control loop 1501.

Accordingly, the maximum power control loop 1500 is inactive during normal operating conditions. For example, during normal operating conditions, the inverter provides less power than its power rating, and thus the error is negative, which saturates PI controller 1504 to a zero value, rendering the maximum power control loop 1500 inactive. As the inverter output power increases above the loop reference P_{maxref}, the PI controller 1504 and rate limiter 1506 produce a frequency offset ωmax, which is subtracted from the no load frequency (ωnl) of the droop curve, thereby reducing the inverter output power until the output power is limited to the maximum reference value set for the loop P_{maxref}.

FIG. 16 is a schematic illustration of a model of a minimum power control loop 1600 in accordance with an embodiment of the present disclosure. The minimum power control loop 1600 limits the active power of an inverter from being negative, because inverters are typically associated with sources that cannot sink power (e.g., fuel cells, solar panels). The minimum power control loop 1600 can also be used more generally to limit the active power of an inverter from decreasing below a minimum setpoint (P_{negref}). In the example of FIG. 16, the loop reference is P_{negref}, which is provided as an input to a positive terminal of error amplifier block 1602. The output of error amplifier block 1602 is provided to PI controller 1604, which applies the transfer function of PI controller 1402, explained above with respect to FIG. 14. In other words, a zero of PI controller 1604 acts as a prefilter cancelling out the pole of the inner droop control loop 1601.

Accordingly, the minimum power control loop 1600 is inactive during normal operating conditions. For example, during normal operating conditions, the inverter provides more power than the negative/minimum power reference, and thus the error is negative, which saturates PI controller 1604 to a zero value, rendering the minimum power control loop 1600 inactive. As the inverter output power decreases below the loop reference P_{negref}, the PI controller 1604 and rate limiter 1606 produce a frequency offset ωneg, which is added to the no load frequency (ω_{NL}) of the droop curve, thereby increasing the inverter output power until the output power is limited to the negative/minimum reference value set for the loop P_{negref}.

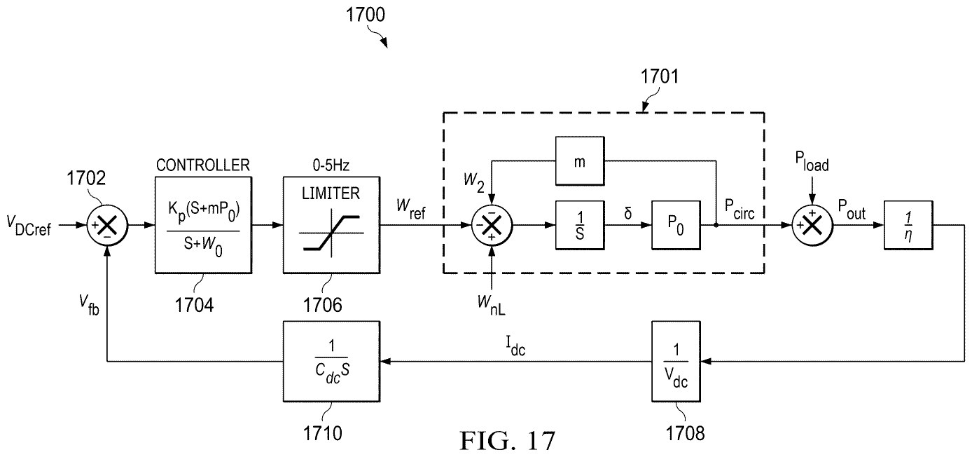

FIG. 17 is a schematic illustration of a model of a DC bus control loop 1700 in accordance with an embodiment of the present disclosure. Power-limited sources, such as fuel cells, solar panels, battery storage, and the like tend to experience decreases in DC bus voltage as the source is limited. This can result in DC bus collapse if the export power of the inverter is not limited. Thus, the DC bus control loop 1700 controls the output power of the inverter based on the DC bus voltage, in order to limit the power exported by the inverter, for example where the fuel source (or solar exposure) becomes limited.

The DC bus control loop 1700 limits the active power of an inverter in response to a voltage of a DC bus of the inverter decreasing below a DC bus loop reference voltage (V_{DCref}). For example, V_{DCref} may be set to a value that prevents the inverter (or source, or other device connected to the DC bus) from tripping due to a DC bus undervoltage condition. In the example of FIG. 17, the loop reference V_{DCref} is provided to a positive terminal of error amplifier block 1702. The output of error amplifier block 1702 is provided to PI controller 1704, which applies the transfer function of PI controller 1402, explained above with respect to FIG. 14. In other words, a zero of PI controller 1704 acts as a prefilter cancelling out the pole of the inner droop control loop 1701.

Accordingly, the DC bus control loop 1700 is inactive during normal operating conditions. For example, during normal operating conditions, the DC bus voltage of the inverter is greater than the DC bus loop reference voltage, and thus the error is negative, which saturates PI controller 1704 to a zero value, rendering the DC bus control loop 1700 inactive. As the DC bus voltage decreases below the loop reference V_{DCref}, the PI controller 1704 and rate limiter 1706 produce a frequency offset ω_{DC}, which is subtracted from the no load frequency (ω_{NL}) of the droop curve, thereby limiting the inverter output power to avoid a DC bus undervoltage condition.

The power output of the inverter is translated to DC bus input power when divided by the efficiency (η). This DC bus input power is divided by the DC bus voltage to give the DC current that charges a capacitor. The DC bus control loop 1700 is closed by multiplying the capacitor current with the capacitor impedance. Because the DC capacitor impedance introduces an additional pole, the system order increases to 2, and the open loop transfer function of the system can be given as:

$$\frac{{V}_{f b} ( s )}{e r r ( s )} = \frac{{K}_{p} ( s + m {P}_{0} )}{s + {ω}_{0}} * \frac{{P}_{0}}{s + m {P}_{0}} * \frac{1}{η {V}_{d c} {C}_{d c} s} \qquad Equation 37$$

The closed loop transfer function for the DC bus control loop 1700 is given as:

$$\frac{{V}_{f b} ( s )}{{V}_{DCref} ( s )} = \frac{{K}_{p} {P}_{0}}{η {V}_{d c} {C}_{d c} {s}^{2} + η {V}_{d c} {C}_{d c} {ω}_{0} s + {K}_{p} {P}_{0}} \qquad Equation 38$$

From Equation 38, the bandwidth of the DC bus control loop 1700 is

$${ω}_{n} = \sqrt{\frac{{K}_{p} {P}_{0}}{η {V}_{d c} {C}_{d c}}} ,$$

and the damping factor of the DC bus control loop 1700 is

$$ε = \frac{{ω}_{0}}{2 * {ω}_{n}} .$$

Accordingly, desired bandwidth and damping factor values for the DC bus control loop 1700 can be achieved by selecting the values of Kₚ and ω₀.

In at least one example embodiment, a method may thus include sensing an output power of an inverter (e.g., inverter 604). As explained above, the inverter 604 is connected to a load 606 and a source, such as a fuel cell, solar panels, or the like. The method may also include applying a droop curve (e.g., block m in the droop control loop 1701) to a component of the output power of the inverter (e.g., the circulating power (P_{circ})) to generate a droop set point frequency in response to the output power.

The method also includes generating a DC frequency by applying a third proportional gain constant and a third integral gain constant (e.g., by PI controller 1702) to a difference between the feedback voltage (V_{fb}) and a reference voltage (V_{DCref} in FIG. 17). As explained above, Kᵢ=mKₚP₀, where P₀ is a system power constant. By selecting the values of the proportional and integral gain constants according to this relationship, as well applying the transfer function according to Equation 33 (e.g., by the PI controller 1702), the method enables achieving a relatively high bandwidth (or any desired bandwidth) while controlling the inverter output power to avoid a DC bus undervoltage condition.

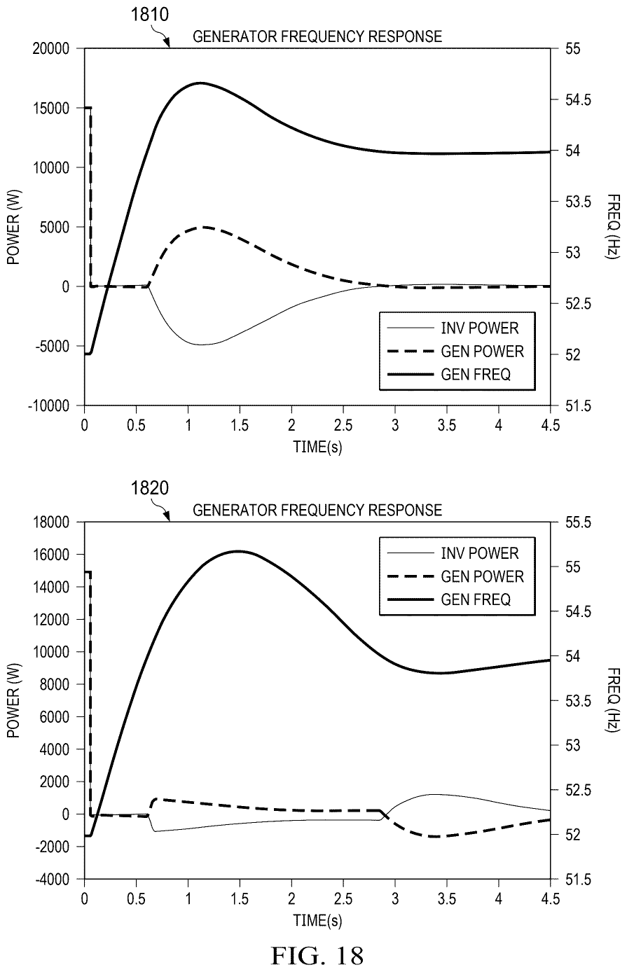

FIG. 18 is a graphical illustration of power and frequency responses of a generator and a grid-forming inverter in response to a step down load condition, which illustrates the effect of the inverter implementing a minimum power control loop in accordance with an embodiment of the present disclosure. FIG. 18 shows a first graph 1810, in which the negative power loop (e.g., as shown in FIG. 16) for the inverter is disabled. FIG. 18 also shows a second graph 1820, in which the negative power loop for the inverter is enabled. In FIG. 18, the simulated load step down is 30 kW, where each source was sharing power equally prior to the load step down (i.e., 15 kW each). The parameters for the simulation in FIG. 18 are the same as were applied in the example of FIG. 7, described above, except that the inertia constant is reduced to 0.3 sec. to more clearly illustrate the overshoot of the synchronous generator.

In the first graph 1810, it is observed that the maximum overshoot of the generator frequency is 54.6 Hz. However, in the second graph 1820, when the negative power loop is enabled for the inverter, the maximum overshoot of the generator frequency is 55.2 Hz, and also has a longer settling time than in the first graph 1810. The simulation of FIG. 18 thus validates the conclusion that the inverter sinking power helps to more quickly (and with less overshoot) recover the generator frequency by dissipating power stored as rotor inertia.

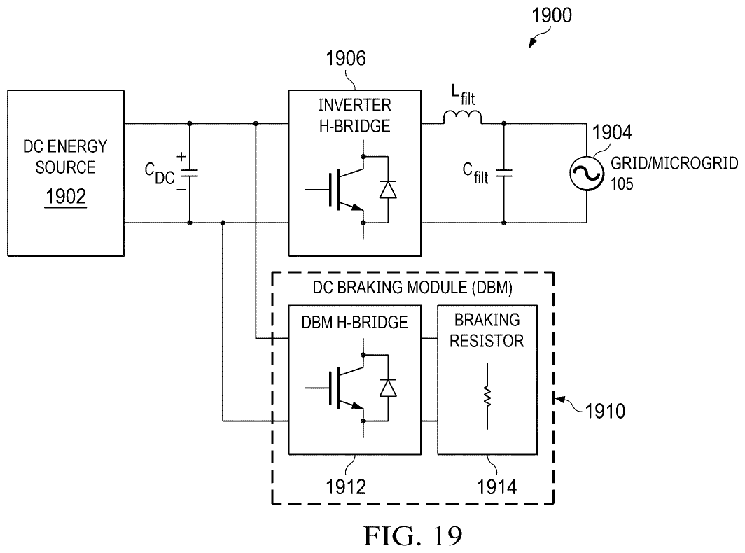

FIG. 19 is a schematic illustration of a system 1900 including a DC braking module (DBM) 1910 in accordance with an embodiment of the present disclosure. As described above, certain energy sources, such as fuel cells and solar panels, cannot sink power. Accordingly, in some embodiments, the DBM 1910 may be added to the DC bus of such sources to dissipate negative power pumped onto the DC bus (e.g., by a synchronous generator). The DBM 1910 may thus protect sources that cannot sink power from DC bus overshoots, as well as improve the stability of associated microgrids by allowing such sources to behave similarly to inertial sources.

In FIG. 19, a DC energy source 1902 provides power to a grid/microgrid 1904, which is regulated by an inverter H-bridge 1906. The DBM 1910 is also coupled to the DC bus of the DC energy source 1902 by a DBM H-bridge 1912. The DBM H-bridge 1912 couples the DC bus to a resistor bank 1914, and thus regulates the voltage applied to the resistor bank 1914 from the DC bus.

The DBM 1910 controls or modulates the voltage applied to the braking resistor load (e.g., resistor bank 1914) by controlling the DBM H-bridge 1912. The DBM H-bridge 1912 generates a fixed-frequency square wave voltage with a peak voltage of V_{dc} (i.e., the voltage of the DC bus). A modulation index (e.g., duty cycle) of the fixed-frequency square wave is controlled through a control loop. For example, ‘D’ is the duty cycle of the square wave generated by the DBM H-bridge 1912, and the RMS voltage of the square wave can be given as:

$${V}_{R M S}^{D B M} = {V}_{d c} \sqrt{D} \qquad Equation 39$$

The resistor bank 1914 may be modeled as a resistor having a resistance value ‘R’. Thus, the corresponding power (P_{DBM}) dissipated by the resistor of value ‘R’ can be given as:

$${P}_{D B M} = \frac{{( {V}_{R M S}^{D B M} )}^{2}}{R} \qquad Equation 40$$

$${P}_{D B M} = \frac{{( {V}_{d c} )}^{2}}{{R}^{2}} * D$$

In Equation 40, both V_{dc} and R are constant values, and thus the power dissipated by the DBM 1910 is proportional to the duty cycle. A control loop may thus be designed based on this linear relationship between dissipated power and duty cycle.

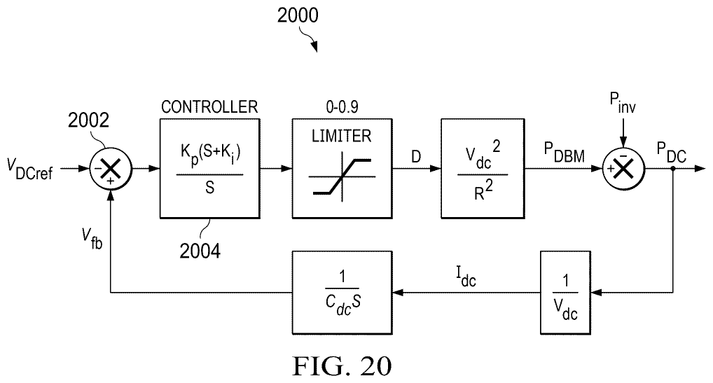

FIG. 20 is a schematic illustration of such a DC braking module control loop 2000 in accordance with an embodiment of the present disclosure. In an example in which negative power is pumped to the DC bus by the inverter, the DC bus voltage will begin to rise. As explained, renewable sources cannot sink power, and will thus go to zero power or no load in such a scenario.

The DC braking module control loop 2000 controls the duty cycle of the DBM H-bridge 1912 to dissipate power that is being fed onto the DC bus by the inverter H-Bridge 1906, when the DC bus voltage is greater than a DC bus reference voltage (V_{DCref}). In the example of FIG. 20, the loop reference V_{DCref} is provided to a positive terminal of error amplifier block 2002. The output of error amplifier block 2002 is provided to PI controller 2004, which applies the transfer function shown in FIG. 20. Accordingly, the DC braking module control loop 2000 is inactive during normal operating conditions (e.g., when there is no negative power). For example, during normal operating conditions, the DC bus voltage will be less than the loop reference V_{DCref}, and thus the PI controller 2004 saturates to a zero value, rendering the DC braking module control loop 2000 inactive.

The open loop transfer function of the DC braking module control loop 2000 can be given as:

$$\frac{{V}_{f b} ( s )}{e r r ( s )} = \frac{( s {K}_{p} + {K}_{i} )}{s} * \frac{{( {V}_{d c} )}^{2}}{{R}^{2}} * \frac{1}{{V}_{d c} {C}_{d c} s} \qquad Equation 41$$

In an example, let

$$\frac{{( {V}_{d c} )}^{2}}{{R}^{2}} = {P}_{d} - dissipation constant ,$$

which is the maximum power dissipation across the resistor bank 1914 for a duty cycle of 1. The closed loop transfer function of the DC braking module control loop 2000 can be given as:

$$\frac{{V}_{f b} ( s )}{{V}_{DCref} ( s )} = \frac{( s {K}_{p} + {K}_{i} ) {P}_{d}}{{V}_{d c} {C}_{d c} {s}^{2} + {K}_{p} {P}_{d} s + {K}_{i} {P}_{d}} \qquad Equation 42$$

Equation 42 demonstrates that the closed loop transfer function represents a second-order system having a bandwidth

$${ω}_{n} = \sqrt{\frac{{K}_{i} {P}_{d}}{{V}_{d c} {c}_{d c}}} ,$$

and a damping factor

$$ε = \frac{{K}_{p} {P}_{d}}{2 {V}_{d c} {C}_{d c} {ω}_{n}}$$

As described above, desired bandwidth and damping factor values for the controller 2000 can be achieved by selecting the values of Ki and Kp. The DC braking module control loop 2000 is thus configured to control the DC bus voltage and dissipate negative power, with a relatively high bandwidth being enabled as well.

In view of the foregoing description, it should be appreciated that a controller for an inverter may implement some or all of the above control loops, including the adaptive ramp rate control loop in FIG. 8, the power control loops of FIGS. 13-16, the DC bus voltage control loop of FIG. 18, and the DC braking module control loop of FIG. 20. Further, the set points (e.g., reference or threshold values) of the various control loops implemented by the controller for the inverter may be set such that all of the implemented loops function independently of and without interfering with one another.

Accordingly, in one embodiment, a microgrid includes a power source, such as a fuel cell, solar panels, or the like, and an inverter electrically coupled thereto. The microgrid also includes a load, to which the inverter provides an output or load power. The inverter includes a controller configured to implement some or all of the control loops described above.

While several embodiments have been shown and described, modifications thereof can be made by one skilled in the art without departing from the scope or teachings herein. The embodiments described herein are exemplary only and are not limiting. Many variations and modifications of the systems, apparatuses, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

While several embodiments have been provided, the disclosed systems and methods may be embodied in other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented. Likewise, where single components, apparatuses, or systems are described as performing functions, multiple such components, apparatuses, or systems may implement the functions.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method, comprising:
controlling an inverter to operate at an initial frequency, wherein the inverter is coupled to a load and a source;
sensing a load power;
generating a droop set point frequency in response to a change in the load power;
applying a first proportional gain constant (Kₚ₁) and a first integral gain constant (Kᵢ₁) to a rate of change of the droop set point frequency to generate an adaptive ramp rate; and
controlling a frequency of the inverter based on the initial frequency and the adaptive ramp rate.

2. The method of claim 1, wherein a difference between a) the frequency of the inverter, and b) a frequency of another power source in response to the change in the load power is reduced based on generating the adaptive ramp rate and controlling the frequency of the inverter based on the initial frequency and the adaptive ramp rate.

3. The method of claim 2, wherein the other power source comprises a synchronous machine or a microgrid comprising a plurality of paralleled sources.

4. The method of claim 1, wherein controlling the frequency of the inverter is further based on applying a rate limiter to the initial frequency.

5. The method of claim 1, wherein the inverter comprises a direct current (DC) bus and a resistor bank coupled to the DC bus by an H-bridge circuit, wherein a voltage applied to the resistor bank is controlled by the H-bridge circuit, and wherein the method further comprises controlling a duty cycle of the H-bridge circuit based on a voltage of the DC bus and a DC bus reference voltage.

6. A method, comprising:
sensing an output power of an inverter, wherein the inverter is coupled to a load and a source;
applying a droop curve (m) to the output power of the inverter to generate a droop set point frequency in response to the output power; and
generating a no load frequency by applying a second proportional gain constant (Kₚ₂) and a second integral gain constant (Kᵢ₂) to a difference between the output power of the inverter and a reference power (P_{ref}),
$$wherein {K}_{i 2} = m * {K}_{p 2} * {P}_{0} ,$$
wherein P₀ is a system power constant, and
wherein the output power of the inverter is controlled based on the no load frequency.

7. The method of claim 6, wherein the reference power is a power rating of the inverter, wherein the power rating of the inverter is provided to a negative input of an error amplifier, wherein the output power of the inverter is provided to a positive input of the error amplifier, and wherein Kₚ₂ and Kᵢ₂ are applied to an output of the error amplifier.

8. The method of claim 6, wherein the reference power is a negative or minimum power rating of the inverter, wherein the negative power rating of the inverter is provided to a positive input of an error amplifier, wherein the output power of the inverter is provided to a negative input of the error amplifier, and wherein Kₚ₂ and Kᵢ₂ are applied to an output of the error amplifier.

9. The method of claim 6, wherein a transfer function (G(s)) of a proportional-integral (PI) controller that applies Kₚ₂ and Kᵢ₂ is given by:
$$G ( s ) = \frac{s {K}_{p 2} + {K}_{i 2}}{s} .$$

10. The method of claim 6, wherein applying Kₚ₂ and Kᵢ₂ to the difference between the output power of the inverter and P_{ref} generates a frequency offset, and wherein the no load frequency is a sum of the frequency offset and a feed forward frequency.

11. A microgrid, comprising:
a power source;
a load; and
an inverter electrically coupled to the power source and configured to provide a load power to the load, wherein the inverter comprises a controller configured to:
control the inverter to operate at an initial frequency;
sense the load power;
generate a droop set point frequency in response to a change in the load power;
apply a first proportional gain constant (Kₚ₁) and a first integral gain constant (Kᵢ₁) to a rate of change of the droop set point frequency to generate an adaptive ramp rate; and
control a frequency of the inverter based on the initial frequency and the adaptive ramp rate.

12. The microgrid of claim 11, wherein a difference between a) the frequency of the inverter, and b) a frequency of another power source in response to the change in the load power is reduced based on generating the adaptive ramp rate and controlling the frequency of the inverter based on the initial frequency and the adaptive ramp rate.

13. The microgrid of claim 12, wherein the other power source comprises a synchronous machine or a microgrid comprising a plurality of paralleled sources.

14. The microgrid of claim 11, wherein controlling the frequency of the inverter is further based on applying a rate limiter to the initial frequency.

15. The microgrid of claim 11, wherein the inverter comprises a direct current (DC) bus and a resistor bank coupled to the DC bus by an H-bridge circuit, wherein a voltage applied to the resistor bank is controlled by the H-bridge circuit, and wherein the method further comprises controlling a duty cycle of the H-bridge circuit based on a voltage of the DC bus and a DC bus reference voltage.

16. A microgrid, comprising:
a power source;
a load; and
an inverter electrically coupled to the power source and configured to provide a load power to the load, wherein the inverter comprises a controller configured to:
apply a droop curve (m) to an output power of the inverter to generate a droop set point frequency in response to the output power; and
generate a no load frequency by applying a second proportional gain constant (Kₚ₂) and a second integral gain constant (Kᵢ₂) to a difference between the output power of the inverter and a reference power (P_{ref}),
$$wherein {K}_{i 2} = m * {K}_{p 2} * {P}_{0} ,$$
wherein P₀ is a system power constant, and
wherein the output power of the inverter is controlled based on the no load frequency.

17. The microgrid of claim 16, wherein the reference power is a power rating of the inverter, wherein the power rating of the inverter is provided to a negative input of an error amplifier, wherein the output power of the inverter is provided to a positive input of the error amplifier, and wherein Kₚ₂ and Kᵢ₂ are applied to an output of the error amplifier.

18. The microgrid of claim 16, wherein the reference power is a negative or minimum power rating of the inverter, wherein the negative power rating of the inverter is provided to a positive input of an error amplifier, wherein the output power of the inverter is provided to a negative input of the error amplifier, and wherein Kₚ₂ and Kᵢ₂ are applied to an output of the error amplifier.

19. The microgrid of claim 16, wherein a transfer function (G(s)) of a proportional-integral (PI) controller that applies Kₚ₂ and Kᵢ₂ is given by:
$$G ( s ) = \frac{s {K}_{p 2} + {K}_{i 2}}{s} .$$

20. The microgrid of claim 16, wherein applying Kₚ₂ and Kᵢ₂ to the difference between the output power of the inverter and P_{ref} generates a frequency offset, and wherein the no load frequency is a sum of the frequency offset and a feed forward frequency.
